(19) United States
(12) Patent Application Publication
(10) Pub. No.: US 2008/0124518 A1
(43) Pub. Date: May 29, 2008

(54) Trim Tuff Anchor

(76) Inventor: Jay Russell McNeill, Flagler Beach, FL (US)

Correspondence Address: Jay R. McNeill, P.O. Box 1292, Flagler Beach, FL, 32136, US

(21) Appl. No.: 11/505,685

(22) Filed: Aug. 18, 2006

Related U.S. Application Data
(60) Provisional application No. 60/726,124, filed on Oct. 13, 2005.

(51) Int. Cl. B32B 3/10

(52) U.S. Cl. 428/131

(57) ABSTRACT

The 2004/05 hurricane seasons caused extensive sign damage warranting a more in-depth look at how signage is installed. Signs blown out during hurricanes become part of the debris field causing extensive damage. The Trim Tuff Anchor will extend the life of signage enabling businesses to save money, operate at maximum capacity, fueling the economy. The Trim Tuff Anchor will help eliminate insurance claims.

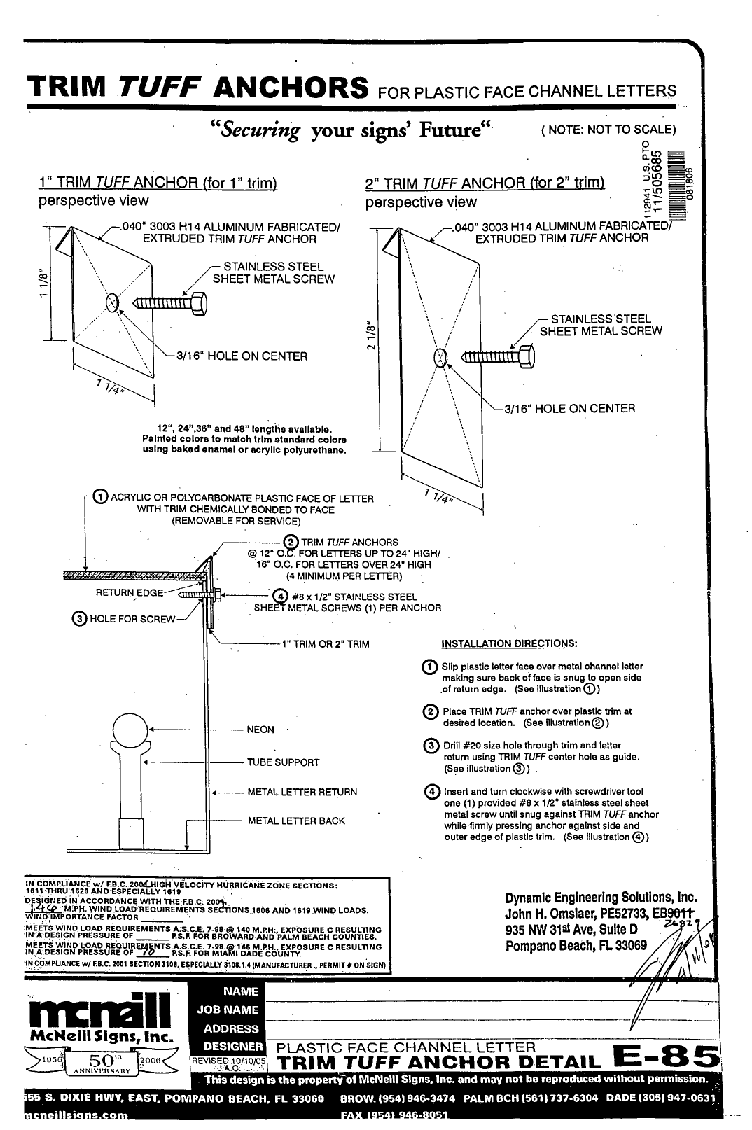

The trim on plastic face signage deteriorates in sun and blows off during windstorms destroying signage and more in the area. The aluminum Trim Tuff Anchor will help to eliminate this problem, strategically placed around the signage they will hold the trim in place, therefore, holding the signage in place.

The Trim Tuff Anchor is inexpensive and necessary. It is recognized that there is a lack of direct provisions for signage. Using wind-load calculations, the Trim Tuff Anchor is a step in the right direction.

### CROSS REFERENCE TO RELATED APPLICATIONS

Provisional Application for Patent Application No. 60/726,124

Confirmation No. 4202

Filing Date Oct. 13,2005

### STATEMENT REGARDING FEDERALLY SPONSORED RESEARCH OR DEVELOPMENT

Not Applicable—There is no entity, whatsoever, that has any interest or rights in this application besides applicant.

### REFERENCE TO SEQUENCE LISTING, A TABLE, OR A COMPUTER PROGRAM LISTING COMPACT DISC APPENDIX

Not Applicable

### BACKGROUND OF THE INVENTION

This Non-Provisional Application for Patent of the Trim Tuff Anchor, an article of manufacture, is to be utilized on plastic face channel letter signage that utilizes plastic trim bordered individual letters. The Trim Tuff Anchor would be an addition to the current standard use. It would be utilized for indoor or outdoor signage. Currently, the plastic face channel letters are held in place by a border trim and screws that are inadequate to withstand some current wind loads and especially after trim has deteriorated from the elements and time. The Trim Tuff Anchor would increase the life of existing deteriorated trim on signage, limit an owner's liability, and help protect signs from windstorm damage which has been rampant in the past two hurricane seasons. The Trim Tuff Anchor is designed for engineering grade performance. See attached letter and calculations from Dynamic Engineering Solutions, Inc.

### BRIEF SUMMARY OF THE INVENTION:

The Trim Tuff Anchor will be utilized in conjunction with the trim around the perimeter retaining plastic face to metal letter pan return that is bordering plastic on channel letters. The Trim Tuff Anchor will anchor/secure the plastic trim to their metal channel letter pan returns. When utilized with any channel letter trim application, the Trim Tuff Anchor is designed to increase wind load exposures to comply with high velocity wind requirements essentially eliminating the signage from becoming airborn projectiles.

### BRIEF DESCRIPTION OF SEVERAL VIEWS OF THE DRAWING:

The Trim Tuff Anchor is fabricated/extruded of aluminum with a simple yet effective design as described on attached drawing #E-85.

### 1″ Trim Tuff Anchor—1″ anchor to accommodate 1″ trim as noted.

### 2″ Trim Tuff Anchor—2″ anchor to accommodate 2″ trim as noted

Side View—Describes mechanically fastening method on anchor to existing trim plastic face channel letter as noted. It is mechanical security to plastic trim utilized on plastic face channel letters or cabinets. Simple installation is required by fastening screw through anchor and letters returns securing plastic face to channel return.

### DETAILED DESCRIPTION OF THE INVENTION

There is not another product in use that the Trim Tuff Anchor is replacing. It is made from 040″ 3003 H13 pre-painted aluminum mechanically broke/extruded across one (1) 1 ¼″ side and one (1) 3/16″ center fastener penetration. Essentially the fastener screw penetrates the Trim Tuff Anchor, plastic trim and metal channel letter return similar to body armor protection.

The Trim Tuff Anchor will come in different sizes and colors to fit any style trim/letter/logo. Custom lengths will also be made available. The variety of colors and custom colors will maximize concealment. It will be especially adequate for 24″ and larger channel letters as larger signs are more vulnerable. The substitute specification includes no new matter.

### DRAWINGS

Enclosed with this package

1. The Trim Tuff Anchor will not only eliminate the trim from tearing off of a sign, it will increase the ability of lettered sign faces to remain in place during high windstorms, resisting wind pressures from any direction or angle.

2. The Trim Tuff Anchor, in aluminum, will add years of life and strength to weather exposed trim and will withstand the most intense UV conditions, thereby extending the life expectancy of deteriorated brittle plastic trim on signage.

3. The Trim Tuff Anchor will save on expensive lettered face sign replacement costs.

4. The Trim Tuff Anchor will minimize liability exposure/insurance costs from falling or flying plastic sign faces resulting from trim UV deterioration or windstorms.

5. Therefore, the Trim Tuff Anchor will increase public safety.
